(19) United States
(12) Patent Application Publication
(10) Pub. No.: US 2011/0122322 A1
(43) Pub. Date: May 26, 2011

(54) Method and apparatus for transmission and reception using power line

(76) Inventor: Woo Yeun Kim, San Diego, CA (US)

(21) Appl. No.: 12/592,390

(22) Filed: Nov. 23, 2009

(51) Int. Cl. H04N 5/38; H04N 5/455

(52) U.S. Cl. 348/723; 348/726; 348/E05.093; 348/E05.1

(57) ABSTRACT

An apparatus for transmission and reception of video signal using power line is provided. The device include a coupler for receiving a high-frequency composite video signal from an external video signal transmitter, a first amplifier, a first low-pass filter, a second amplifier, a second low-pass filter, an FM demodulator, a video amplifier, an analog-digital converter, an image processor, and a universal serial bus (USB) host for processing a video file from the image processor so as to be adapted to be displayed on the personal computer and outputting to a USB port or storing in a memory.

### BACKGROUND OF THE INVENTION

The present invention relates to a method and apparatus for transmission and reception using power line.

### SUMMARY OF THE INVENTION

The present invention contrives to solve the disadvantages of the prior art.

An object of the invention is to provide a method and apparatus for transmission and reception using power line, in which the signals from a video camera are transmitted through a power line.

An aspect of the invention provides a power line communication camera comprising: a transmitter for receiving a composite video signal from a video camera, modulating the composite video signal to obtain radio frequency-modulated signals, and transmitting the obtained radio frequency-modulated signals through a power line; a receiver for receiving the radio frequency-modulated signals, demodulating the received radio frequency-modulated signals to obtain composite video output; an analog-digital converter for converting the composite video output to digital signals; a digital signal processing unit for image-processing of the digital signals; and a video compressing unit for compressing the image-processed digital signals.

The compressed image-processed digital signals are configured to be displayed on a display, stored in a memory, and searched in real-time in a computer.

The transmitter may comprise: a low-pass filter for receiving the composite video signal and outputting a low-pass filtered composite video signal; a voltage controlled oscillator for receiving the low-pass filtered composite video signal; a wide-band tuning varactor for receiving signals from the voltage controlled oscillator and outputting an intermediate frequency (IF) signal; a mixer for mixing the IF signal with an RF signal and outputting the mixed signal; an amplifier for amplify the mixed signal from the mixer; and a coupler for receiving the amplified signal through a band-pass filter and transmitting the received amplified signal to the power line.

The transmitter may further comprise a power supply tapping the power line, and the power supply may comprise a transformer and a regulator.

The receiver may comprise: a coupler for extracting RF signals from the power line; a first amplifier for amplifying the extracted RF signals; a first low-pass filter for filtering the first-amplified RF signals; a second amplifier for amplifying the first-filtered RF signals; a second low-pass filter for filtering the second-amplified RF signals; a baseband demodulator for obtaining video baseband signals from the second-filtered RF signals; a video amplifier for amplifying the video baseband signals; and a third low-pass filter for filtering the amplified vide baseband signals and obtaining composite video signals.

The receiver may further comprise a power supply tapping the power line, and the power supply may comprise a transformer and two or more regulator.

The video amplifier may comprise: a third amplifier; a low-pass filter; and a fourth amplifier, and an output of the third amplifier may be directed to an input of the fourth amplifier through the low-pass filter.

The compressed image-processed digital signals may be configured to be connected to the display, the memory, and the computer through universal serial bus (USB).

Another aspect of the invention provides an apparatus for transmission of video signal using power line comprising: a low-pass filter for receiving a composite video signal from a camera and outputting a low-pass filtered composite video signal; an analog-digital converter for converting the low-pass filtered composite video signal from the low-pass filter to RF video signal; a first band-pass filter for band-pass filtering the RF video signal from the analog-digital converter; an amplifier for amplify the RF video signal from the first band-pass filter to a level adapted to be transmitted through a power line; a second band-pass filter for band-pass filtering the amplified RF video signal; and a coupler for receiving the RF video signal from the second band-pass filter and transmitting the RF video signal through the power line.

Still another aspect of the invention provides an apparatus for reception of video signal comprising: a coupler for receiving a high-frequency composite video signal from an external video signal transmitter through a power line, a wall outlet, and a plug and extracting an RF composite video signal from the power line; a first amplifier for amplifying the extracted RF composite video signal from the coupler; a first low-pass filter for filtering the RF signal amplified by the first amplifier; a second amplifier for amplifying the filtered RF signal to a predetermined level; a second low-pass filter for filtering the RF signal amplified by the second amplifier; an FM demodulator for obtaining original composite video signal by demodulating the RF signal from the second low-pass filter; a video amplifier for amplifying the demodulated video signal by the FM demodulator using amplifying low-pass filter and outputting to a video output; an analog-digital converter for converting an analog composite video signal processed by the video amplifier to a digital composite video signal; an image processor for converting a file format of the video data from the analog-digital converter to another file format adapted to be used in a personal computer or on a world wide web; and a universal serial bus (USB) host for processing a video file from the image processor so as to be adapted to be displayed on the personal computer and outputting to a USB port or storing in a memory.

The power line may comprise a power line for supplying a commercial or residential electrical power.

The video amplifier may comprise: a third amplifier for firstly amplifying the video signal demodulated by the FM demodulator to a desired level; a third low-pass filter for filtering the video signal amplified by the third amplifier; and a fourth amplifier for secondly amplifying the video signal from the third low-pass filter and outputting to the video output.

The apparatus may further comprise: a transformer for stepping up or down a power from the power line to a desired level of voltage for the apparatus; and a regulator for receiving an arbitrary level of voltage from the transformer and outputting a predetermined level of voltage.

The device according to the invention has advantages of using power line to transmit a video signal.

### BRIEF DESCRIPTION OF THE DRAWINGS

These and other features, aspects and advantages of the present invention will become better understood with reference to the accompanying drawings, wherein:

FIG. 1 is a block diagram showing an apparatus for transmission of video signal using power line according to an embodiment of the present invention;

FIG. 2 is a detailed block diagram showing an apparatus for transmission of video signal using power line according to an embodiment of the present invention;

FIG. 3 is a block diagram showing an apparatus for reception of video signal using power line according to an embodiment of the present invention; and

FIG. 4 is a detailed block diagram showing an apparatus for reception of video signal using power line according to an embodiment of the present invention.

### DETAILED DESCRIPTION EMBODIMENTS OF THE INVENTION

The invention relates to an apparatus for transmission and reception of video signal using power line, in which the video signal a camera can be transmitted to a PC or TV through a power line for displaying.

In prior arts, the video clips obtained from the camera must be stored in a storing device of the camera, and a user has to bring the storing device to a PC or TV for displaying. Therefore, it was not convenient to handle the video clip in transmitting, accessing, and viewing.

The present invention is for solving the above problems of the prior arts.

Using the apparatus according to the invention, the video signal can be transmitted to a PC or TV directly through the power line, or accessed through the PC, which can be viewed or handled remotely by a user using the Internet.

An aspect of the invention provides a power line communication camera comprising: a transmitter 120 for receiving a composite video signal from a video camera, modulating the composite video signal to obtain radio frequency-modulated signals, and transmitting the obtained radio frequency-modulated signals through a power line; a receiver 320 for receiving the radio frequency-modulated signals, demodulating the received radio frequency-modulated signals to obtain composite video output; an analog-digital converter 122 for converting the composite video output to digital signals; a digital signal processing unit (not shown) for image-processing of the digital signals; and a video compressing unit (not shown) for compressing the image-processed digital signals.

The compressed image-processed digital signals are configured to be displayed on a display 330, 350, stored in a memory 340, and searched in real-time in a computer 340.

The transmitter 120 may comprise: a low-pass filter for receiving the composite video signal and outputting a low-pass filtered composite video signal; a voltage controlled oscillator for receiving the low-pass filtered composite video signal; a wide-band tuning varactor for receiving signals from the voltage controlled oscillator and outputting an IF signal; a mixer for mixing the IF signal with an RF signal and outputting the mixed signal; an amplifier for amplify the mixed signal from the mixer; and a coupler for receiving the amplified signal through a band-pass filter and transmitting the received amplified signal to the power line.

The transmitter may further comprise a power supply tapping the power line, and the power supply may comprise a transformer and a regulator.

The receiver may comprise: a coupler for extracting RF signals from the power line; a first amplifier for amplifying the extracted RF signals; a first low-pass filter for filtering the first-amplified RF signals; a second amplifier for amplifying the first-filtered RF signals; a second low-pass filter for filtering the second-amplified RF signals; a baseband demodulator for obtaining video baseband signals from the second-filtered RF signals; a video amplifier for amplifying the video baseband signals; and a third low-pass filter for filtering the amplified vide baseband signals and obtaining composite video signals.

The receiver may further comprise a power supply tapping the power line, and the power supply may comprise a transformer and two or more regulator.

The video amplifier may comprise: a third amplifier; a low-pass filter; and a fourth amplifier, and an output of the third amplifier may be directed to an input of the fourth amplifier through the low-pass filter.

The compressed image-processed digital signals may be configured to be connected to the display, the memory, and the computer through universal serial bus (USB).

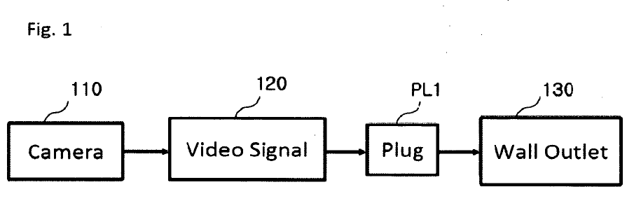

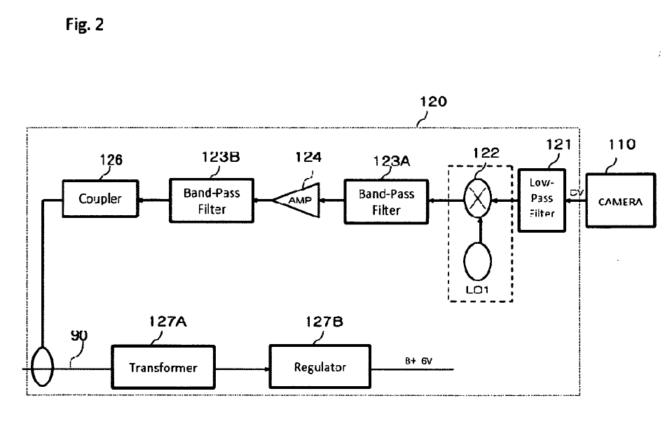

As shown in FIGS. 1 and 2, another aspect of the invention provides an apparatus for transmission of video signal 120 comprising: a low-pass filter 121 for receiving a composite video signal from a camera 110 and outputting a low-pass filtered composite video signal; an analog-digital converter 122 for converting the low-pass filtered composite video signal from the low-pass filter 121 to RF video signal; a first band-pass filter 123A for band-pass filtering the RF video signal from the analog-digital converter 122; an amplifier 124 for amplify the RF video signal from the first band-pass filter 123A to a level adapted to be transmitted through a power line 90; a second band-pass filter 123B for band-pass filtering the amplified RF video signal; and a coupler 126 for receiving the RF video signal from the second band-pass filter 123B and transmitting the RF video signal through the power line 90.

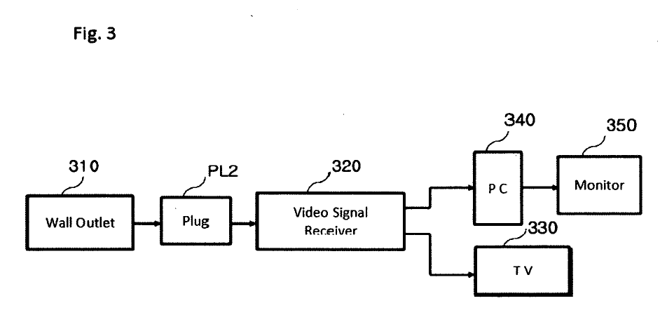

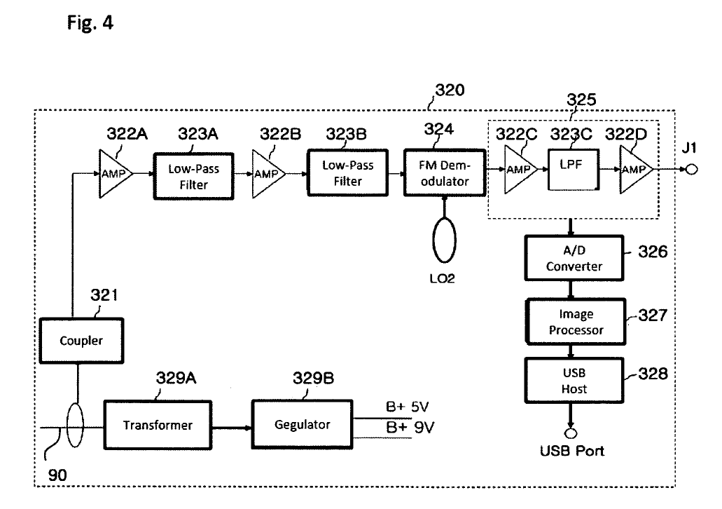

As shown in FIGS. 3 and 4, still another aspect of the invention provides an apparatus for reception of video signal 320 comprising: a coupler 321 for receiving a high-frequency composite video signal from an external video signal transmitter through a power line 90, a wall outlet 310, and a plug PL2 and extracting an RF composite video signal from the power line 90; a first amplifier 322A for amplifying the extracted RF composite video signal from the coupler 321; a first low-pass filter 323A for filtering the RF signal amplified by the first amplifier 322A; a second amplifier 322B for amplifying the filtered RF signal to a predetermined level; a second low-pass filter 323B for filtering the RF signal amplified by the second amplifier 322B; an FM demodulator 324 for obtaining original composite video signal by demodulating the RF signal from the second low-pass filter 323B; a video amplifier 325 for amplifying the demodulated video signal by the FM demodulator 324 using amplifying low-pass filter and outputting to a video output J1; an analog-digital converter 326 for converting an analog composite video signal processed by the video amplifier 325 to a digital composite video signal; an image processor 327 for converting a file format of the video data from the analog-digital converter 326 to another file format adapted to be used in a personal computer 340 or on a world wide web; and a universal serial bus (USB) host 328 for processing a video file from the image processor 327 so as to be adapted to be displayed on the personal computer 340 and outputting to a USB port or storing in a memory.

The power line 90 may comprise a power line for supplying a commercial or residential electrical power.

The video amplifier 325 may comprise: a third amplifier 322C for firstly amplifying the video signal demodulated by the FM demodulator 324 to a desired level; a third low-pass filter 323C for filtering the video signal amplified by the third amplifier 322C; and a fourth amplifier 322D for secondly amplifying the video signal from the third low-pass filter 323C and outputting to the video output.

The apparatus may further comprise: a transformer 329A for stepping up or down a power from the power line 90 to a desired level of voltage for the apparatus; and a regulator 329B for receiving an arbitrary level of voltage from the transformer 329A and outputting a predetermined level of voltage.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. An apparatus for transmission of video signal using power line comprising:
a low-pass filter for receiving a composite video signal from a camera and outputting a low-pass filtered composite video signal;
an analog-digital converter for converting the low-pass filtered composite video signal from the low-pass filter to RF video signal;
a first band-pass filter for band-pass filtering the RF video signal from the analog-digital converter;
an amplifier for amplify the RF video signal from the first band-pass filter to a level adapted to be transmitted through a power line;
a second band-pass filter for band-pass filtering the amplified RF video signal; and
a coupler for receiving the RF video signal from the second band-pass filter and transmitting the RF video signal through the power line.

2. An apparatus for reception of video signal using power line comprising:
a coupler for receiving a high-frequency composite video signal from an external video signal transmitter through a power line, a wall outlet, and a plug and extracting an RF composite video signal from the power line;
a first amplifier for amplifying the extracted RF composite video signal from the coupler;
a first low-pass filter for filtering the RF signal amplified by the first amplifier;
a second amplifier for amplifying the filtered RF signal to a predetermined level;
a second low-pass filter for filtering the RF signal amplified by the second amplifier;
an FM demodulator for obtaining original composite video signal by demodulating the RF signal from the second low-pass filter;
a video amplifier for amplifying the demodulated video signal by the FM demodulator using amplifying low-pass filter and outputting to a video output;
an analog-digital converter for converting an analog composite video signal processed by the video amplifier to a digital composite video signal;
an image processor for converting a file format of the video data from the analog-digital converter to another file format adapted to be used in a personal computer or on a world wide web; and
a universal serial bus (USB) host for processing a video file from the image processor so as to be adapted to be displayed on the personal computer and outputting to a USB port or storing in a memory.

3. The apparatus of claim 2, wherein the power line comprises a power line for supplying a commercial or residential electrical power.

4. The apparatus of claim 2, wherein the video amplifier comprises:
a third amplifier for firstly amplifying the video signal demodulated by the FM demodulator to a desired level;
a third low-pass filter for filtering the video signal amplified by the third amplifier; and
a fourth amplifier for secondly amplifying the video signal from the third low-pass filter and outputting to the video output.

5. The apparatus of claim 2, further comprising:
a transformer for stepping up or down a power from the power line to a desired level of voltage for the apparatus; and
a regulator for receiving an arbitrary level of voltage from the transformer and outputting a predetermined level of voltage.
